(19) United States
(12) Patent Application Publication
(10) Pub. No.: US 2009/0065453 A1
(43) Pub. Date: Mar. 12, 2009

(54) Nesting and Stacking Document or File Sorter

(76) Inventor: Aaron W. Smith, Plainfield, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/854,263

(22) Filed: Sep. 12, 2007

(51) Int. Cl. B42F 7/00

(52) U.S. Cl. 211/11; 211/45; 211/59.2

(57) ABSTRACT

A sorter has a pair of laterally spaced apart wire supports. A platform is disposed between the pair of wire supports. A plurality of dividers is spaced apart from one another along the wire supports. Each divider extends generally upward and laterally outward from a respective wire support. The sorter can be stacked upon and nested with multiple like sorters.

### BACKGROUND

1. Field of the Disclosure

The present disclosure is generally related to document and file organization and storage products, and more particularly to a nestable and stackable sorters for files, documents, and the like.

2. Description of Related Art

Storage and organizer products for documents, file folders, and the like are known. However, such products generally either have open sides with no boundaries to prevent files or documents from laterally moving within the product, or the known products have solid side walls that limit lateral movement of documents or files, but the solid side walls require a great deal of material to form.

Additionally, known storage and organizer products are typically not nestable and stackable relative to one another when using more than two of such products. Thus, retail shelf space usage is not maximized. A typical organizer or sorter product can only be stacked with one other identical product by inverting one of the products, rotating it 180 degrees, and placing it on top of and nesting it with the other of the products. Sorter products stacked and nested in this manner are susceptible to movement relative to one another, and can be damaged. Such products also take up significant amounts of space during shipping, storage, and within retail shelf space.

These types of products are typically individually packaged or packaged in pairs for shipping. Upon being prepared to be displayed for sale, the products are then unpackaged by the retailer if packaged in pairs.

### BRIEF DESCRIPTION OF THE DRAWINGS

Objects, features, and advantages of the present disclosure will become apparent upon reading the following description in conjunction with the drawing figures, in which:

FIG. 1 shows a top perspective view of one example of a sorter constructed in accordance with the teachings of the present disclosure.

FIG. 2 shows a front view of the sorter of FIG. 1.

FIG. 3 shows a top view of the sorter of FIG. 1.

FIG. 4 shows a side view of the sorter of FIG. 1.

FIG. 5 shows a rear view of the sorter of FIG. 1.

FIG. 6 shows a bottom view of the sorter of FIG. 1.

FIG. 7 shows a perspective view of three of the sorters of FIG. 1 and arranged in one example of a stacked and nested configuration.

FIG. 8 shows a top perspective view of a second example of a sorter constructed in accordance with the teachings of the present disclosure.

FIG. 9 shows a perspective view of three of the sorters of FIG. 8 and arranged in one example of a stacked and nested configuration.

FIG. 10 shows a top perspective view of a third example of a sorter constructed in accordance with the teachings of the present invention.

FIG. 11 shows a front view of the sorter of FIG. 11.

FIG. 12 shows a top view of the sorter of FIG. 11.

FIG. 13 shows a side view of the sorter of FIG. 11.

FIG. 14 shows a front perspective view of the sorter of FIG. 10 supporting a file folder.

### DETAILED DESCRIPTION OF THE PREFERRED EMBODIMENTS

The present disclosure is generally directed to a sorter for organizing and storing documents, file folders, and the like in a generally upright orientation. The disclosed sorter has cantilevered wire dividers that extend upwards from a pair of wire supports. The wire dividers are connected at upper edges thereof by a side wire. The side wire forms a lateral stop for any document or file disposed in the sorter. A platform is disposed between the pair of wire supports to provide stability to the stored documents or files.

Additionally, the disclosed sorter can be stacked and nested with a plurality of identical sorters in order to reduce the space necessary for shipping, storage, and retail display. By nesting and stacking a large number of identical sorters, the sorters can also be tightly packed. Thus, the sorters may move relatively little or not at all relative to one another during shipping. This further reduces the possibility of the products becoming scratched or scraped.

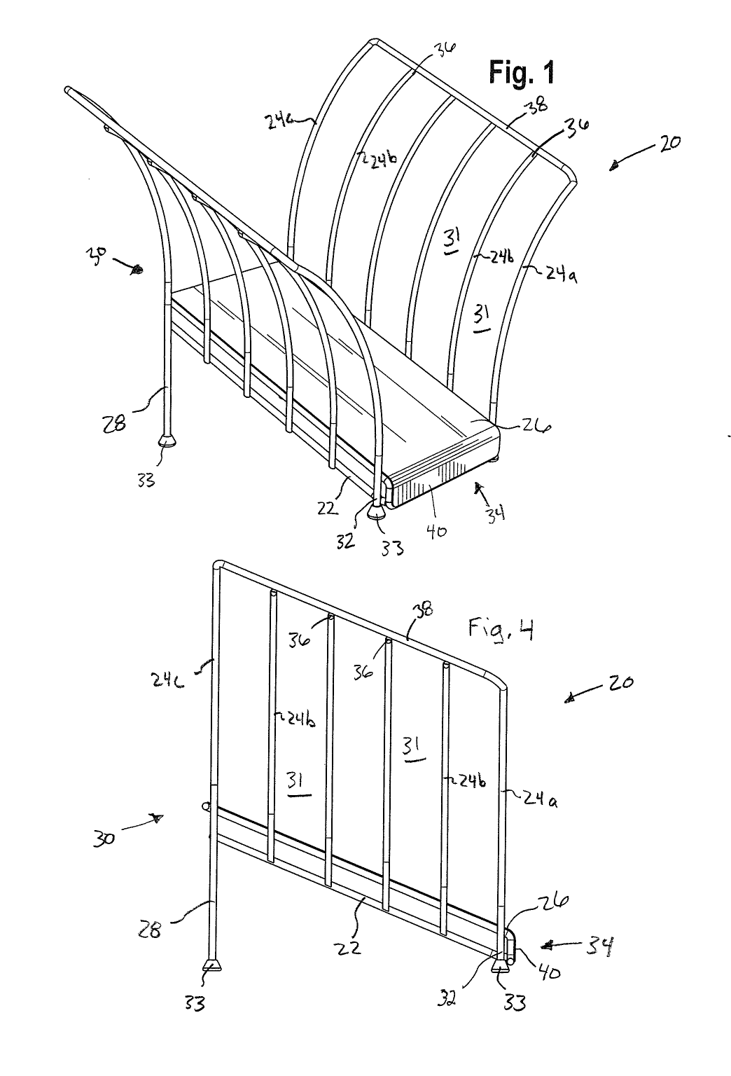

Turning now to the drawings, FIG. 1 illustrates a perspective view of one example of a document sorter 20 constructed in accordance with the teachings of the present disclosure. The document sorter 20 generally includes a pair of wire support beams 22, a plurality of cantilevered wire dividers 24, a center platform 26, a pair of wire rear legs 28 extending downward from a rear end 30 of the sorter 20, and a pair of wire front legs 32 extending from a front end 34 of the sorter 20. The front and rear legs 28, 32 are shown in this embodiment with feet 33. The feet 33 may be removed without significantly affecting the stability of the sorter 20. The rear legs 28 elevate the rear end 30 upwardly relative to the front end 34 and tilt the wire support beams 22 in an upward and rearward direction. Thus, the platform 26 is angled relative to a plane defined by distal ends of the front and rear legs 32, 28. The platform 26 may be inclined relative to the plane defined by the distal ends of the front and rear legs 32, 28 between approximately 0 degrees and approximately 75 degrees. In a preferred embodiment, the platform 26 may inclined at an angle between approximately 10 degrees and approximately 50 degrees. The dividers are hereinafter collectively identified as dividers 24, but specifically include a front or forward most divider 24a positioned near front ends of the pair of wire supports 22, a plurality of intermediate dividers 24b, and a rear or back divider 24c positioned near rear ends of the pair of wire supports. When referring to the dividers generally, they are referred to by reference number 24. When referring to specific dividers, the reference numbers 24a, 24b, or 24c are used.

The dividers 24 are attached to the wire supports 22 in a cantilevered fashion and extend upward from the wire supports 22 and outward away from the platform 26. The dividers 24 are spaced apart between the front end 34 and the rear end 30 of the sorter 20. In this example, the dividers are at equidistant spacing relative to each other. Storage gaps or spaces 31 are formed between adjacent ones of the dividers 24, with the storage spaces 31 being of uniform depth as a result of equidistant spacing of the dividers 24. However, the dividers 24 may be spaced in a non-uniform manner to accommodate different thicknesses of documents, files, etc.

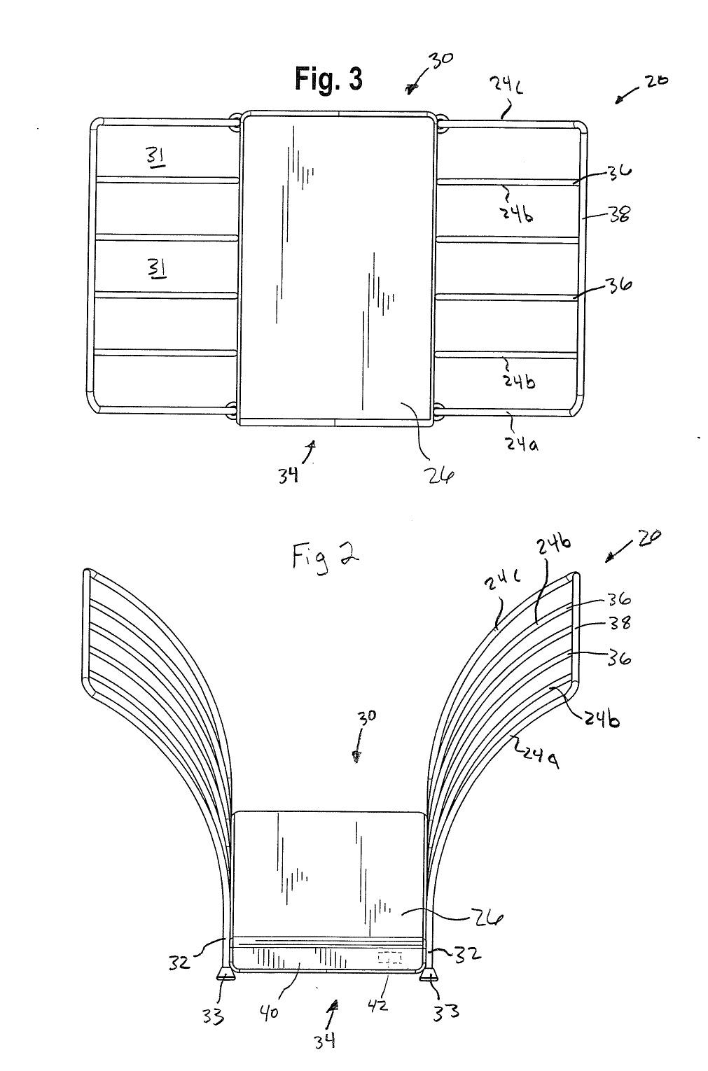

In the disclosed example shown in FIGS. 1-6, each of the dividers 24 has an arcuate or curved shape. The curved shape of the dividers 24 is generally concave relative to the platform 26. However, other embodiments of the sorter 20 may have dividers 24 with a generally convex curve relative to the platform 26 or dividers 24 that are substantially straight. The front divider 24a continues downward from the wire support 22 and forms the front leg 32. Likewise, the rear divider 24c continues downward from the wire support 22 and forms the rear leg 28. However, the front and rear legs 32, 28 may be formed of separate wires from the front and rear legs 32, 28 if desired. The shape of the dividers 24 can also vary within the spirit and scope of the present invention. The shape of the dividers 24 need not be any particular shape. In fact, the dividers 24 can be any shape suitable for supporting file folders, documents, and the like within the spaces 31 of the sorter 20 and allowing like sorters 20 to nest with one another as will be discussed further below. The shape of the dividers 24 may include, for example, curved, straight, curvilinear, etc. Moreover, each of the dividers 24 may have its own individual shape that is different from the rest of the dividers 24.

The distal ends 36 of the dividers 24 may be connected with a side wire 38. The side wire 38 provides a lateral limit or stop, beyond which a document or file disposed within the sorter 20 cannot slide. The side wire 38 forms the lateral limit using a minimal amount of material. In other embodiments, the front divider 24a, the side wire 38 and the rear divider 24c may be formed from a continuous piece of wire.

The size of the dividers 24 in the disclosed example are such that the side wire 38 is below at least a portion of a height of a file or folder stored therein. Thus, a user can easily read a file or other object to view any labels or content indicators and can grasp objects stored in the sorter along virtually any of three edges or corners of the article. However, the dividers 24 should be of sufficient width and sufficient height to bear against a sufficient portion of a file, folder, document, or other article or object stored in the sorter so that the object is adequately supported in a substantially upright orientation.

The platform 26 is substantially straight. However, other embodiments may have a convexly or concavely curved platform relative to a plane defined by the distal ends of the front and rear feet 28, 32. Yet Other embodiments may have a curvilinear platform 26. Moreover, the platform 26 need not be a solid surface, but could be a wire mesh surface, or the platform 26 may be eliminated all together, if desired, leaving the wire supports 22 as a bearing surface for a bottom edge of a file or folder disposed in the sorter 20. The platform 26 shown in the embodiment of FIGS. 1-6 includes a front lip 40. The front lip 40 may include an area for a logo or label 42 (see FIG. 2).

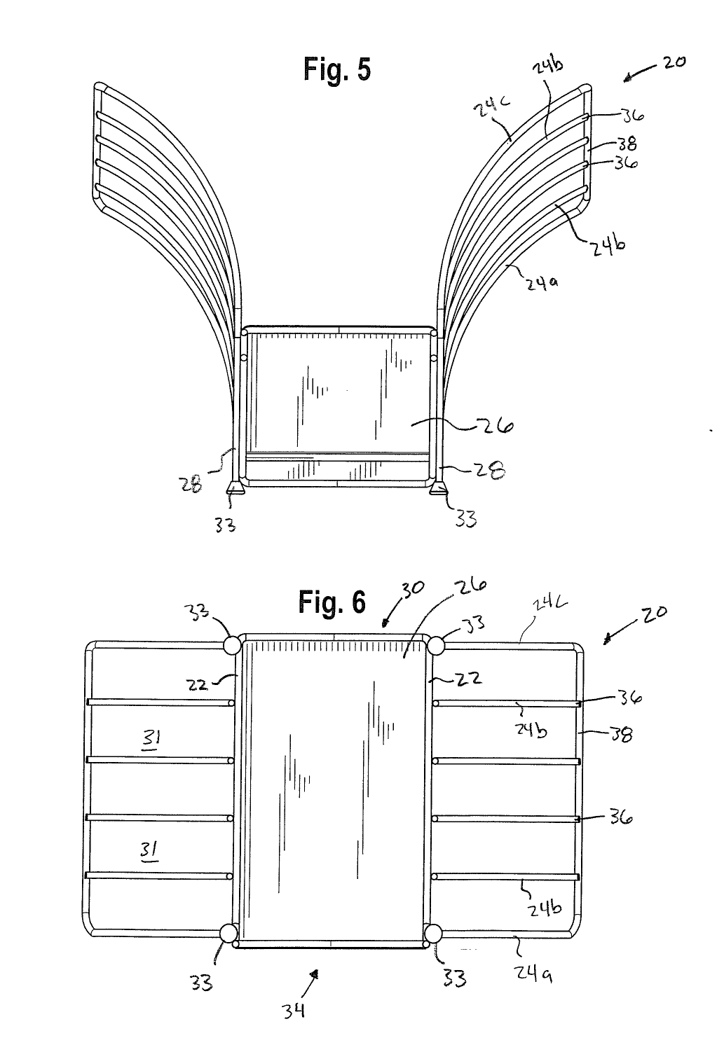

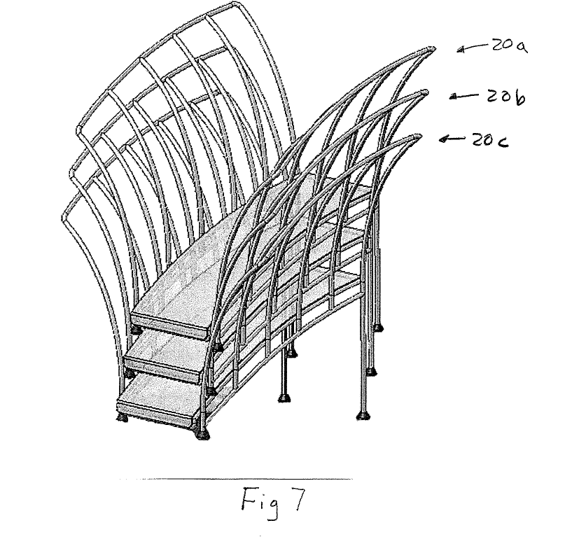

The area within the gaps 31 is open between adjacent dividers 24. As a result, multiple sorters 20a, 20b, 20c of similar construction can be nested relative to and stacked upon one another as illustrated in FIG. 7. The dividers of a upper-most sorter 20a can be received through the openings in the gaps 31 of a next adjacent lower sorter 20b in a stack. The front or forward most divider 24a of the lower most sorter 20c in the stack is positioned forward of the front divider 24a of the next upwardly adjacent stacked sorter 20b. Each next successively-stacked sorter is similarly positioned or offset behind the front divider 24a of the previous sorter. The rear legs 28 of each sorter are positioned behind the previously stacked sorter. Additionally, the pair of wire supports 22 of the lower-most sorter 20c underlies the pair of wire supports 22 of the sorter 20b immediately above the lower-most sorter 20c. In this manner, a number of sorters can be stacked and nested relative to one another as depicted in FIG. 5. Only three such sorters 20a, 20b, 20c are depicted therein, with room for one or more additional sorters in the stack.

A second embodiment of a sorter constructed in accordance with the teachings of the disclosure is shown in FIGS. 8 and 9. Like elements are shown with reference numbers being exactly 100 greater than the elements shown in the embodiment of FIGS. 1-6. The sorter 120 of FIGS. 8 and 9 differs from the sorter 20 of FIGS. 1-6 in that each rear leg 128 and each front leg 132 connects with another rear leg 128 and front leg 132 respectively to form continuous front and rear feet 133. Additionally, the front legs 132 are an extension of the front lip 140 of the platform 126 instead of being an extension of the front divider 124a.

Like the embodiment of FIGS. 1-6, the sorter 120 of FIGS. 8 and 9 is nestable and stackable with like sorters 120 as shown in FIG. 9. The dividers of a upper most sorter 120a can be received through the openings in the gaps 131 of a next adjacent lower sorter 120b in a stack. The front or forward most divider 124a of the lower most sorter 120c in the stack is positioned forward of the front divider 124a of the next upwardly adjacent stacked sorter 120b. Each next upwardly stacked sorter is similarly positioned or offset behind the previous sorter front divider 124a. The rear legs 128 of each sorter are positioned behind the previously stacked sorter. In this manner, that number of sorters can be stacked and nested relative to one another as depicted in FIG. 9. Only three such sorters 120a, 120b, 120c are depicted therein, with room for one or more additional sorters in the stack.

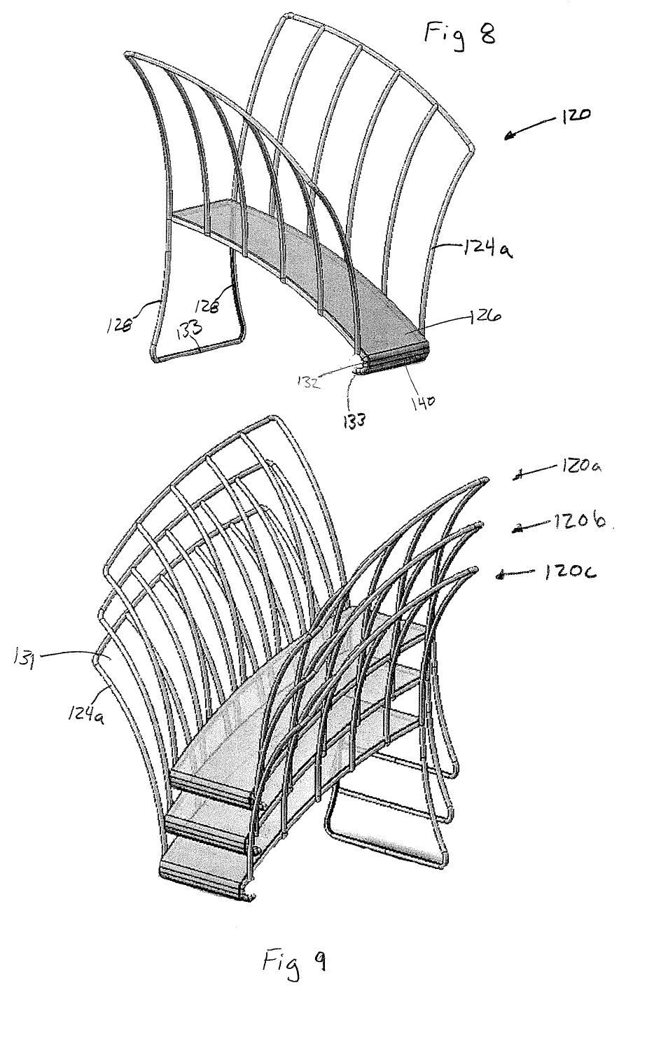

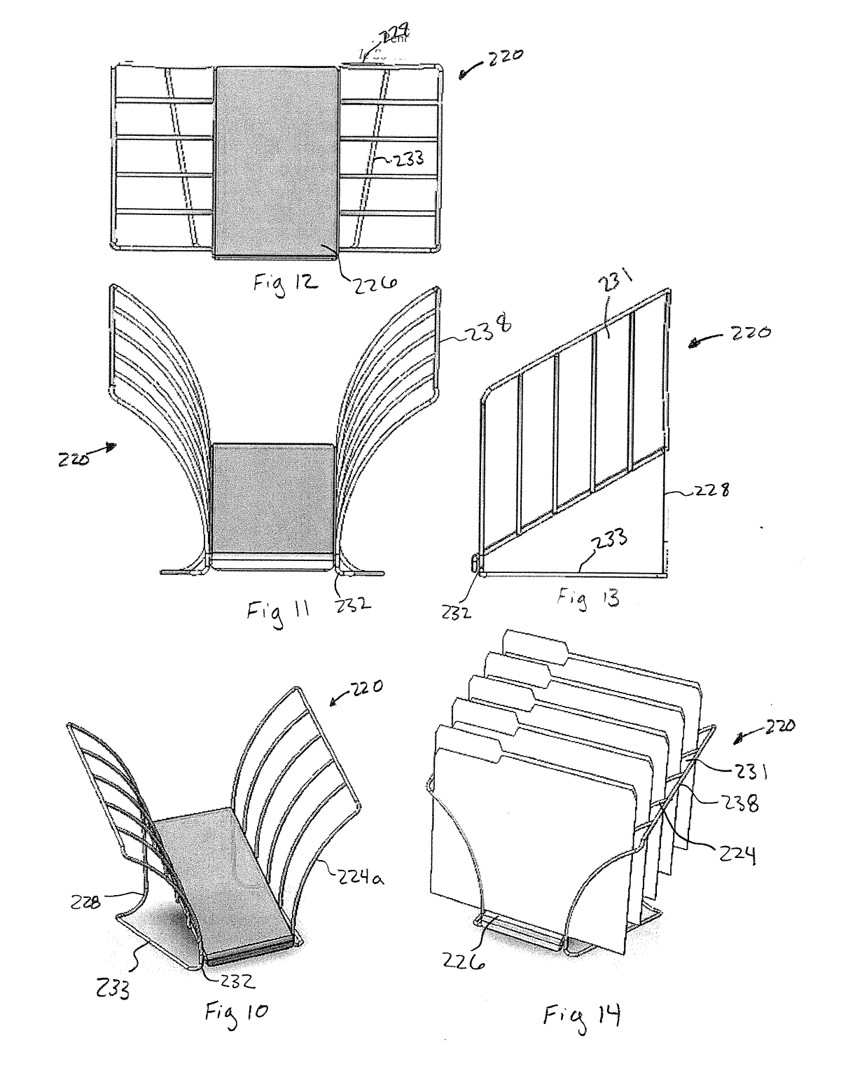

A third embodiment of a sorter constructed in accordance with the teachings of the invention is shown in FIGS. 10-14. Like elements are shown with reference numbers being exactly 200 greater than the elements shown in the embodiment of FIG. 16. The sorter 220 of FIGS. 10-14 differs from the sorter 20 of FIGS. 1-6 in that the rear legs 228 connect with the front legs 232 to form continuous side feet 233 on each side of the sorter 220. The front legs 232 are an extension of the front divider 224a, like the embodiment of FIGS. 1-6.

As shown in FIG. 14, files, folders, and the like that are stored in the gaps 231 between dividers 224 of the disclosed sorters will also rest on the top surface of the platform 226. As noted above, the size of the dividers can be such that parts of the stored objects extend above the side wires 238. The exposed parts of the objects can thus be easily seen and grasped as needed.

Merchandisers and retailers of upright orientation document sorters typically provide shelf space and retail arrangements that vary from store to store and from retailer to retailer. Thus, a product configuration that is suitable for display in a shelf space at one location may not be suitable for a shelf space or configuration at another location. The disclosed sorters permit stacking and nesting of multiple products. The disclosed sorters can thus be displayed, packaged, shipped, stocked, stored, and the like within a relatively small amount of shelf space.

By maximizing packaging and shipping space as well as store shelf space utilizing the disclosed document sorter configurations, one is able to package, ship and store a larger product volume per unit area. This creates more space within an existing product display in a limited shelf space arrangement that may have been originally suited for a completely different product. This can increase revenue dollars for the retailer per square foot of shelf space. This can also permit adding the disclosed article holders to an existing shelf space without having to knock out another product from that shelf space.

Sorters for storing items such as file folders, documents, and the like in an upright orientation have not heretofore been designed for nestability in the manner disclosed herein. Some solutions have been provided, but these typically require that the sorters being offered for sale be provided in several pieces, partially dismantled, or as stand alone units. Also, such products typically are packaged with cardboard, Styrofoam, plastic film and the like to protect the articles from being damaged by one another, such as by being scuffed, scratched, or the like, while being shipped or while on display for sale.

In contrast, the disclosed document sorter configurations may eliminate the need for utilizing foam, paper, corrugated elements, poly bags, or other such packing materials. Instead, the disclosed sorters can be shipped, stored, and displayed in tightly nested stacks. The stacks will provide stability to the shipped, stored, and displayed products. The products can stand alone in stacks without additional packing in shipping containers or on a shelf storage space for sale.

Some other existing office products of the type described herein are capable of nesting, but only with one other like product. Further, one of the two products must be inverted or turned upside down and rotated 180 degrees relative to the other in order to nest. These types of products, however, must still utilize additional packing to prevent the products from moving relative to one another during shipping and display, which would otherwise cause scuffing or scratching. Such known products do not typically optimize product nesting or reduce shelf space to the degree that the disclosed sorters can accomplish.

The disclosed sorters achieve the objective of substantially reducing the necessary space required for shipping, storage, and retail sale, while still maintaining standard function for such products. Additionally, the disclosed sorters provide a lateral stop for file folders or documents stored therein, the lateral stops being formed with a minimal amount of material, thus reducing unit costs. The disclosed sorters can nest bi-directionally, i.e., horizontally offset and vertically, while still meeting the aforementioned function and minimizing the possibility of product damage during shipping.

The materials and processes used to manufacture the disclosed article holders can vary considerably and yet fall within the spirit and scope of the present invention. However, in one example, the platforms of the sorters disclosed herein can be manufactured using an injection molding process, sheet metal, bent wire, wood or fiber board, fabricated plastic sheet rock, formed metal mesh with metal trim, cold-cast resin, rubber, or a combination of materials.

The disclosed sorter configurations improve upon maximizing retail shelf space, accommodate variable shelf space arrangements and configurations, and enhance product nesting during display for sale. Product nesting is accomplished in a bi-directional manner to yield a stack with offset in both a horizontal and a vertical direction. The stacked products can be displayed and shipped without damage to the product caused by scuffing, scrapping, and the like because the products can be tightly nested. The need for additional packing can be negated. The disclosed sorters can also provide multiple access points to the stored objects so that a user can easily grasp materials stored between the dividers.

Additionally, freight cube size can be optimized and significantly reduced utilizing the disclosed sorter configurations. Products shipped in bulk can be directly unloaded from the master carton or shipping box onto a shelf. No additional reorientation of the product may be necessary, making the merchandiser's handling of the product easier. The nested products can also assist in retaining the displayed sorters on a retail shelf space. The products when nested as disclosed herein also look more organized. This reduces the amount of work required by the customer/merchandiser to keep the shelf display organized and arranged. An organized shelf space may effect the perception of the consumer and influence his or her decision to buy the displayed sorters.

Further, because more products can be displayed for sale in a given amount of shelf space, less restocking time and stocking space is necessary for the retailer. Having more products available for sale at any one time reduces the frequency of an item appearing to be out of stock, which can prevent a consumer from leaving the establishment to go elsewhere to find the desired product.

Although certain document and file sorters that are nestable and stackable have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A sorter comprising:
a pair of laterally spaced apart wire supports;
a platform disposed between the wire supports;
a plurality of cantilevered wire dividers extending generally upward and outward, away from respective wire supports, the plurality of wire dividers spaced apart from one another, the plurality of wire dividers including a front wire divider positioned near front ends of the pair of wire supports, a rear divider positioned near rear ends of the pair of wire supports and an intermediate wire divider therebetween; and
a side wire connecting distal ends of the wire dividers.

2. The sorter of claim 1, wherein the pair of wire supports is inclined upward at an angle toward the rear ends thereof.

3. The sorter of claim 2, wherein the angle of inclination is in the range of approximately 0 degrees and approximately 70 degrees.

4. The sorter of claim 2, wherein the angle of inclination is in the range of approximately 10 degrees and approximately 40 degrees.

5. The sorter of claim 1, further including a rear leg extending from the rear end of each wire support, the rear leg being of sufficient height to elevate a rear of the sorter relative to a front of the sorter.

6. The sorter of claim 5, including two rear legs, each substantially a continuation of the rear divider.

7. The sorter of claim 6, wherein the two rear legs are connected to form a continuous rear foot.

8. The sorter of claim 6, including two front legs.

9. The sorter of claim 8, wherein the two front legs are connected to form a continuous front foot.

10. The sorter of claim 8, wherein respective rear and front legs are connected to form a continuous side foot on each side of the sorter.

11. The sorter of claim 1, wherein each of the pair of wire supports is straight.

12. The sorter of claim 1, wherein the platform is curved.

13. The sorter of claim 12, wherein the platform curvature is concave relative to the pair of wire supports.

14. The sorter of claim 1, wherein at least one divider in the plurality of wire dividers is curved.

15. The sorter of claim 14, wherein the at least one divider is concavely curved relative to the platform.

16. A stack of sorters, the stack comprising:
a plurality of sorters, each sorter including:
a pair of laterally spaced apart wire supports;
a platform disposed between the wire supports;
a plurality of wire dividers extending generally vertically and outward, away from respective wire supports, the plurality of wire dividers spaced apart from one another, the plurality of wire dividers including a front wire divider positioned near front ends of the pair of wire supports, a rear divider positioned near rear ends of the pair of wire supports and an intermediate wire divider therebetween; and
a side wire connecting distal ends of the wire dividers
wherein a first sorter in the plurality of sorters is vertically stacked with a second sorter in the plurality of sorters and wherein the dividers of the first sorter are received between dividers of the second sorter and the wire supports of the second sorter underlie the wire supports of the first sorter providing a nested configuration.

17. The sorter of claim 16, wherein the front wire divider of the second sorter is positioned forward of the front wire divider of the first sorter.

18. The sorter of claim 17, including a plurality of intermediate wire dividers.
